(19) United States
(12) Patent Application Publication
(10) Pub. No.: US 2018/0205752 A1
(43) Pub. Date: Jul. 19, 2018

(54) Security Breach Detection in a Digital Medium Environment

(71) Applicant: Adobe Systems Incorporated, San Jose, CA (US)

(72) Inventors: Yi Liu, Mountain View, CA (US); Krishna Kishore Veturi, San Jose, CA (US); Kourosh Modarresi, Los Altos, CA (US)

(73) Assignee: Adobe Systems Incorporated, San Jose, CA (US)

(21) Appl. No.: 15/406,494

(22) Filed: Jan. 13, 2017

(51) Int. Cl. H04L 29/06

(52) U.S. Cl. CPC H04L 63/1425; H04L 63/1441

(57) ABSTRACT

Security breach detection techniques in a digital medium environment are described. In one example, usage behavior data is received that describes a number of actions taken by users with respect to digital content of a service provider system over time. A plurality of action distributions is generated based on the usage behavior data. The plurality of action distributions describes a change in the number of actions taken by the users with respect to the digital content over time. A security breach likelihood is detected of a user account of the service provider system by comparing usage behavior data associated with the user account with the generated plurality of action distributions. A result of the detection is then output.

### BACKGROUND

Service provider systems that provide access to digital content “in the cloud” have become one of the primary techniques by which users access computing functionality, such as via web services, online applications, and so forth. In one example, a user obtains a subscription to the service provider system to access the digital content via a respective user account. The user may then access the service provider system using a respective computing device (e.g., mobile phone, desktop computer) to interact with the digital content via the user account. A variety of types of interactions may be supported by the service provider system with the digital content, such as for online storage, productivity software, digital content creation and modification, and so forth.

As access via a network to service provider systems has increased in popularity, so too has the attempts by malicious parties to gain unauthorized access to these systems, which is commonly referred to as a security breach. This unauthorized access may result in harm to both the users that access the service (e.g., due to lost or corrupted digital content, misrepresentation of a user associated with a user account of the service provider system) as well as the service provider system in lost revenue and damage to the service provider system's brand. Although conventional techniques have been developed to detect potential security breaches, these conventional techniques are typically static and as such do not adapt to changes in usage behavior over time. This may therefore result in additional user frustration and damage to the service provider's brand caused by misidentification of security breaches, e.g., as false positives that might cause the user's account to be wrongly shut down.

### SUMMARY

Security breach detection techniques and systems in a digital medium environment are described that are configured to address changes in usage behavior of a user population with respect to a service provider system over time. As a result, these techniques and systems have increased accuracy versus conventional techniques in identification of security breaches and protection against false positives (e.g., detecting a security breach when none has in fact occurred) and false negatives (e.g., not detecting a security breach when in fact a security breach has occurred).

In one example, usage behavior data is received by a security breach detection module that describes a number of actions performed with respect to digital content of a service provider system over time. The actions, for instance, may result from user interaction of a user population with a service provider system to initiate operations of a computing device, such as a cut-and-paste operation, selection of a menu item, and so forth.

A plurality of action distributions is then generated by the security breach detection module based on the usage behavior data. The plurality of action distributions describes a change in the number of actions taken by the users with respect to the digital content over time. Thus, the action distributions describe changes in behavior of the user population that occurs over time with respect to the digital content.

A security breach likelihood is detected of a user account of the service provider system by comparing usage behavior data associated with the user account with the generated plurality of action distributions. The security breach detection module, for instance, may be configured to investigate a likelihood that a particular user account has been breached. To do so, usage behavior data from the user account is compared with the action distributions to determine whether a change in behavior exhibited by the user account is consistent with changes that are exhibited by the user population, if any. In this way, changes in usage behavior may be addressed and reduce a likelihood of errors such as false positives.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of a digital medium environment in an example implementation that is operable to employ security breach detection techniques described herein.

FIG. 2 depicts a system in an example implementation in which operation of a security breach detection module of FIG. 1 is shown in greater detail.

FIG. 3 is a flow diagram depicting a procedure in an example implementation in which changes in a number of actions with respect to digital content by a user population over time is used to detect a security breach of a user account of a service provider.

FIG. 4 depicts a histogram for Z-values tabulated for an action.

FIG. 5 is an illustration of a plot for Z-values.

FIG. 6 depicts a receiver operating curve that compares true discovery rate with false discovery rate.

FIG. 7 depicts a histogram for a distribution of an area under a receiver operating curve.

FIG. 8 is a flow diagram depicting a procedure in an example implementation in which a determination is made as to a relative consistency in a change in behavior by a user with respect to a user population.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

Overview

Security breaches by malicious parties are a significant problem for service provider systems that provide online access via a network to digital content, such as online applications, storage, and so forth. Although conventional techniques have been developed to detect possible security breaches, these conventional techniques typically rely on a fixed model of characteristics of a user behavior (e.g., change in IP address, change in the user locations, etc.) such that any change in these characteristics with respect of a service provider system may be flagged as a potential security breach. Accordingly, because user behavior may change over time with respect to the service provider system, these conventional techniques often result in errors including high false positives (e.g., detecting a security breach when none has in fact occurred). Thus, conventional techniques may result in user frustration, may be resource intensive by requiring engineers at the service provider system to manually investigate these errors, and result in decreased revenue and damage user perception of the service provider system.

Techniques and systems are described that address changes in actions of a user population with respect to digital content over time. In one example, these techniques and systems are configured to detect a security breach of a user account of a service provider system. To do so, usage behavior data is collected from a user population by a security breach detection module. The usage behavior data describes a number of actions taken by respective users (e.g., via respective user accounts) with respect to digital content of the service provider system over a plurality of periods of time, e.g., same month of different years. The actions, for instance, may include operations initiated by a computing device via the user account with respect to digital content, such as selection of menu items, keyboard combinations (e.g., cut-and-paste operation), types of digital content with which a user has interacted (e.g., particular applications, images, or other computing resources), and so forth.

Based on this usage behavior data, the security breach detection module generates a plurality of action distributions, each action distribution corresponding to a respective action taken with respect to the digital content of the service provider system. Each action distribution describes a change in the number of times individual ones of a plurality of actions are taken by the users in the user population with respect to the digital content over time, e.g., over the plurality of periods of time such as the same month of different years above. As such, the plurality of action distributions describes changes in user behavior exhibited by the user population with respect to the digital content based on changes in number of different types of respective actions performed by respective users of the user population.

The security breach detection module then leverages the plurality of action distributions generated for the plurality of actions taken by the user population to detect a likelihood of a security breach. The security breach detection module, for instance, may compare usage behavior data associated with one user account under investigation with the plurality of action distributions. The comparison acts as a basis to determine whether a change in user behavior exhibited by the usage behavior data associated with the user account is or is not consistent with changes exhibited by the action distributions of the user population, which the security breach detection module then indicates as a likely security breach.

In this way, the security breach detection module may address potential changes in a user behavior over time with respect to a service provider system as part of determining a likelihood of a security breach. Further, the service provider system is protected against false positives and false negatives that may result from changes in the user behavior. Although security breach detection is described in the following by way of example, detection of changes in behavior of a user population as described in the following may also support a variety of other functionality. An example of this functionality includes a digital marketing context to address changes in a segment of a user population that serves as a basis to target digital marketing content, e.g., online advertisements, banner ads, notifications, and so forth.

### Term Examples

“Digital content” may take a variety of forms, such as an online application, online storage, web service, digital images, digital audio, multimedia, and so forth.

“Actions” involving access to the digital content may also take a variety of forms, such as selection of a menu item, voice command, gesture, subject matter of the digital content (e.g., of an illustration), key combination, and so forth.

“Usage behavior data” describes actions taken with respect to the digital content by a user population. The usage behavior data may describe a number of times individual ones of a plurality of actions are taken by individual users (e.g., via respective user accounts of a service provider system) over a period of time, e.g., during different time intervals such as hours, days, weeks, months, seasons, and so forth.

“Action distributions” describe how a number of times an action is performed changes over time. In one example, action distributions are described through use of binomial distribution. The action distribution can be transformed into a normal distribution as complying with the Central Limit Theorem.

A “binomial distribution” is an algebraic expression of the sum of many independent actions of similar kind.

In the following discussion, an example environment is described that may employ the techniques described herein. Example procedures are also described which may be performed in the example environment as well as other environments. Consequently, performance of the example procedures is not limited to the example environment and the example environment is not limited to performance of the example procedures.

Example Environment

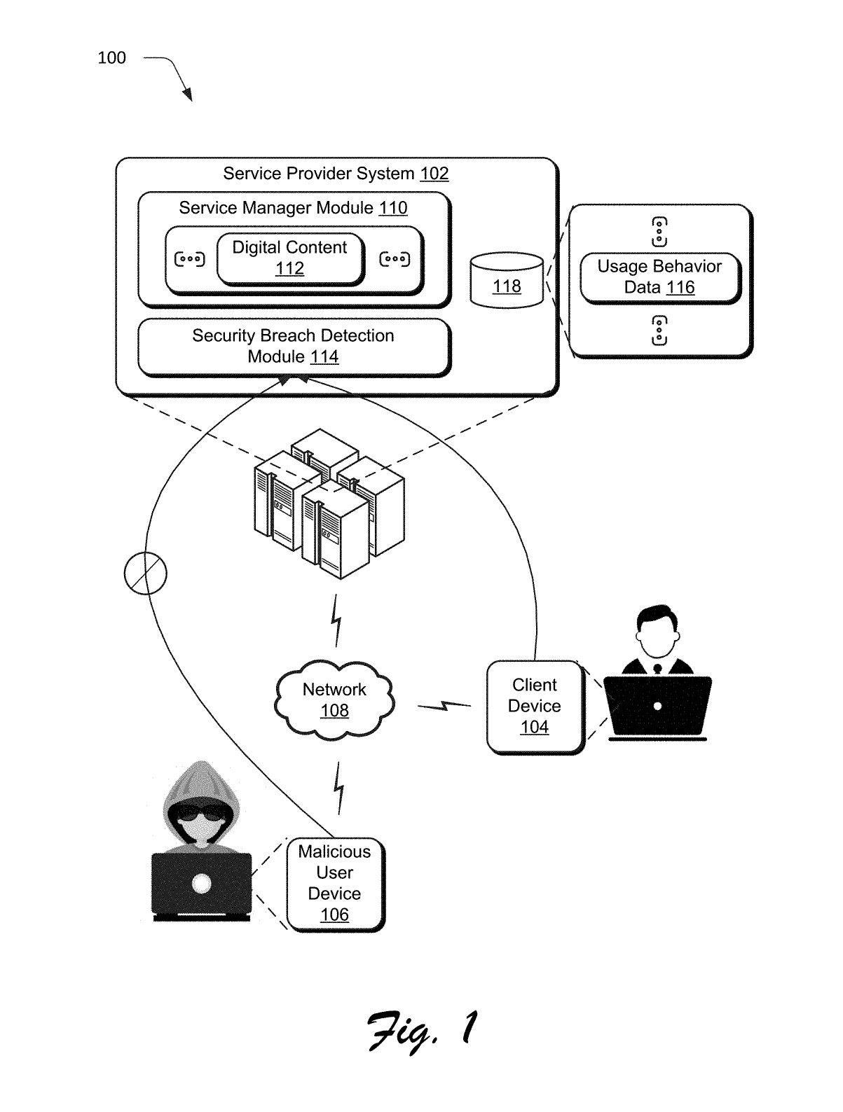

FIG. 1 is an illustration of a digital medium environment 100 in an example implementation that is operable to employ security breach detection techniques described herein. The illustrated environment 100 includes a service provider system 102, a client device 104, and a malicious user device 106 that are communicatively coupled, one to another, via a network 108. Computing devices that implement the service provider system 102, the client device 104, and the malicious user device 106 may be configured in a variety of ways.

A computing device, for instance, may be configured as a desktop computer, a laptop computer, a mobile device (e.g., assuming a handheld configuration such as a tablet or mobile phone), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is shown in some examples, the computing device may be representative of a plurality of different devices, such as multiple servers utilized by a business to perform operations “over the cloud” as shown for the service provider system 102 and as further described in FIG. 9.

The service provider system 102 is illustrated as including a service manager module 110 that is implemented at least partially in hardware of a computing device. The service manager module 110 is configured to manage online interaction with digital content 112 of the service provider system 102 via the network 108. As previously described, the digital content 112 may take a variety of forms, such as an online application, online storage, web service, digital images, digital audio, multimedia, and so forth. Thus, actions involving access to the digital content 112 by the client device 104 via the network 108 may also take a variety of forms, such as selection of a menu item, voice command, gesture, subject matter of the digital content 112 (e.g., of an illustration), key combination, and so forth.

A user of client device 104, for instance, may create the digital content 112 by accessing the service manager module 110 via the network 108, such as to create an illustration, movie, audio data, and so forth. This may include execution of applications locally by the client device 104 and remotely by the service provider system 102 that both involve actions taken with respect to the digital content 112. As part of this, a user of the client device 104 may initiate operations involving interaction with the digital content 112, such as to draw a line, color a shape, enter text, and so forth. Thus, initiation of these operations is considered performance of an action involving interaction with the digital content 112. Other examples are also contemplated in which the digital content 112 is an application, web service, and so forth and thus different interactions with the digital content 112 (e.g., a user interface of the digital content 112) also correspond to different actions, e.g., selection of a link, an item in a user interface, and so forth.

The service provider system 102 is also illustrated as including a security breach detection module 114. The security breach detection module 114 is configured to detect a likelihood of a security breach that takes into account changes in usage behavior of a user population over time. In this way, the search breach detection module 114 may accurately distinguish between actions that are likely taken by a user of the client device 104 that has legitimate access to the digital content 112 from actions taken by a malicious user of the malicious user device 106. This is not possible in conventional techniques that rely on a static model of user behavior and thus are incapable of addressing these changes.

To do so, the security breach detection module 114 collects usage behavior data 116, which is illustrated as stored in storage 118. The usage behavior data 116 describes actions taken with respect to the digital content 112 by a user population. The usage behavior data 116, for instance, may describe a number of times individual ones of a plurality of actions are taken by individual users (e.g., via respective user accounts of the service provider system 102) over a period of time, e.g., during different time intervals such as hours, days, weeks, months, seasons, and so forth. For example, each user of the user population may have a user account to access the digital content 112 of the service provider system 102, e.g., accessed through a subscription or otherwise. Actions performed via the respective user accounts is then monitored and collected as usage behavior data 116 by the security breach data module 114. As previously described, actions may take a variety of forms including initiation of operations of a computing device regarding digital content 112, e.g., a number of cut-and-paste operations, selections of particular menu items, use of particular gestures, spoken utterances, and so forth.

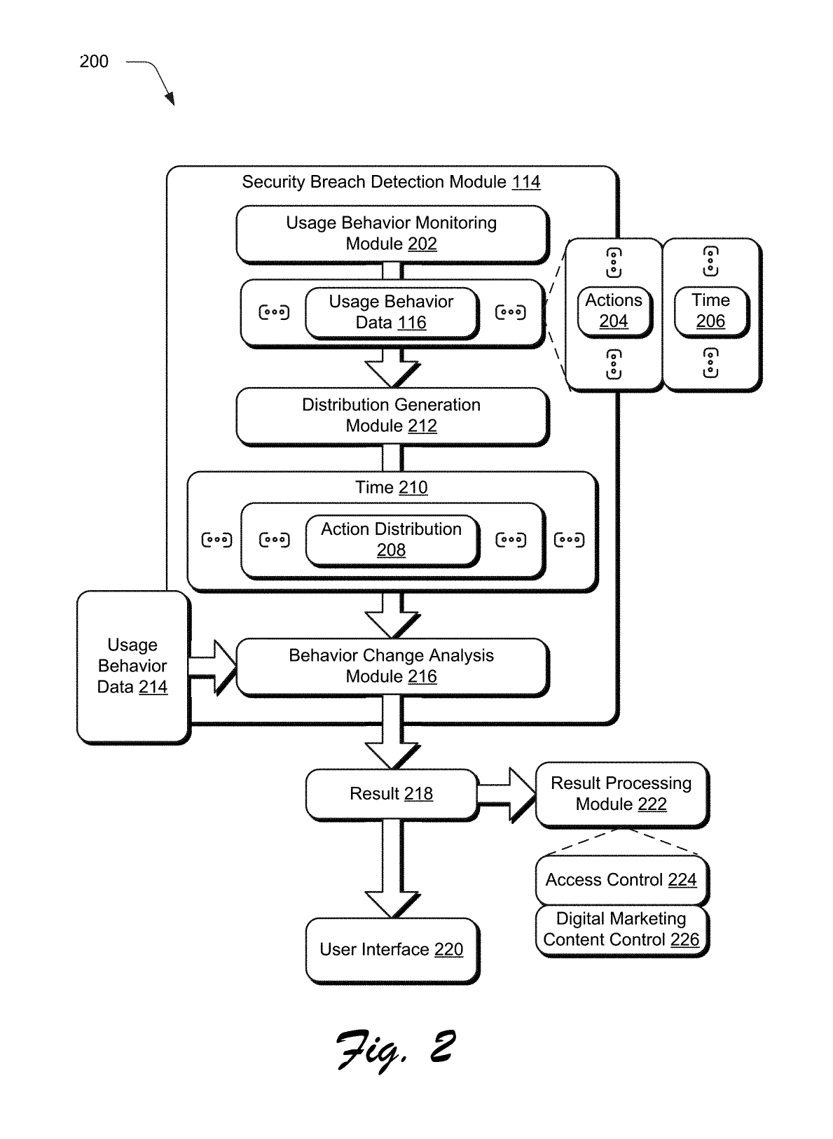

The security breach detection module 114 then determines how the number of actions changes over time for the user population described by the usage behavior data 116. In one example, this is performed by the security breach detection module 114 through calculation of an action distribution for each of the plurality of actions monitored by the security breach detection module 114 as further described in relation to FIG. 2. The action distribution describes mathematically how a number of actions performed by the user population changes over time, e.g., as a normal distribution.

From this determination, the security breach detection module 114 detects whether a change in usage behavior associated with a particular user account of the service provider system 102 follows changes exhibited by the user population as a whole as described by the action distribution for each of the plurality of actions. In this way, the security breach detection module 114 is able to determine whether access to a particular user account of the service provider system 102 is likely legitimate as corresponding to legitimate user of the client device 104 or likely a security breach by a malicious user through interaction with a malicious user device 106. The security breach detection module 114 may then output a result of this detection, such as in a user interface to bring the possibility of the security breach to the attention of an engineer at the service provider system 102, to restrict access to a user account by the malicious user device 106 automatically and without user intervention, and so forth. Further discussion of these and other examples is included in the following description and shown in corresponding figures.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

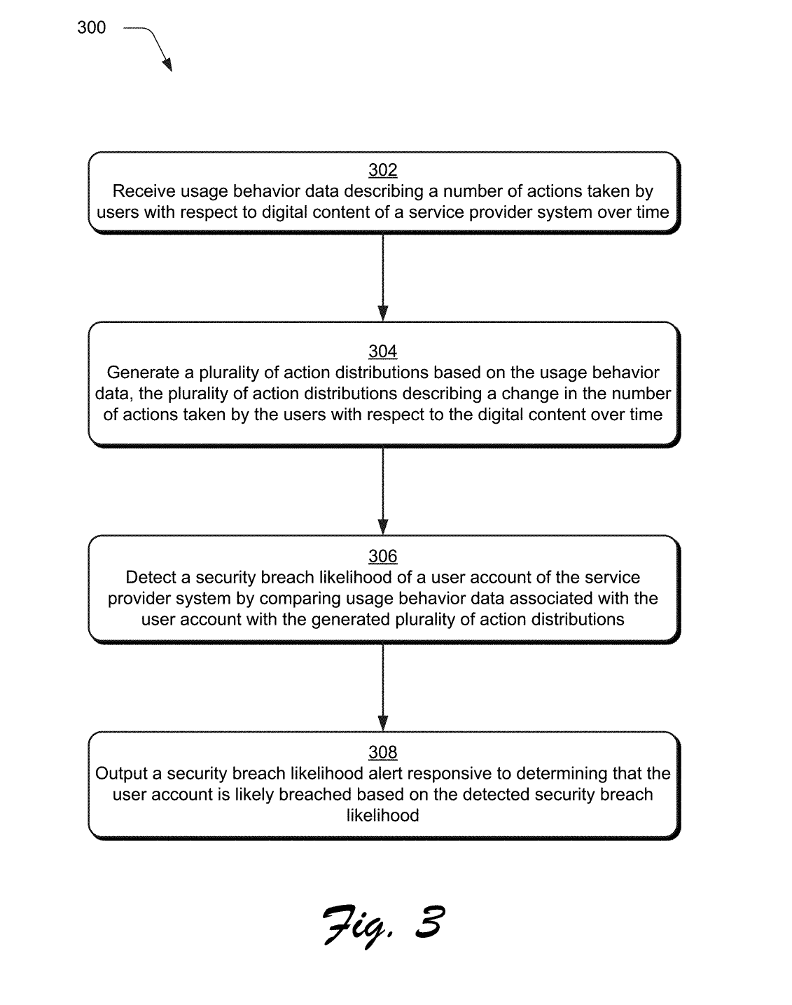

FIG. 2 depicts a system 200 in an example implementation in which operation of the security breach detection module 114 is shown in greater detail. FIG. 3 depicts a procedure 300 in an example implementation in which changes in a number of actions with respect to digital content by a user population over time is used to detect a security breach of a user account of a service provider. The following discussion alternates between FIGS. 2 and 3.

The following discussion describes techniques that may be implemented utilizing the described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks.

To begin, usage behavior data is received that describes a number of actions taken by users with respect to digital content of a service provider system over time (block 302). A usage behavior monitoring module 202 of the security breach detection module 114, for instance, may monitor interaction of a user population with digital content 112. This includes monitoring actions 204 taken with respect to the digital content 112 and a time 206 at which those actions were taken. Each of the actions 204, for instance, may be assigned the time 206 as a timestamp. In another example, the usage behavior data 116 represents a number of actions 204 taken for a corresponding time 206 period, e.g., hour, day, week, month, season, holiday, year, and so forth.

As previously described, the digital content 112 and consequently actions taken with respect to the digital content 112 may take a variety of forms. Digital content 112, for instance, may represent an application or web service with which a user population interacts. In another instance, the digital content 112 represents subject matter of the application or web service, such as a drawing, audio data, video data, or the like being created, modified, or otherwise interacted with by users through respective computing devices via the network 108.

The usage behavior monitoring module 202 thus monitors which actions 204 are taken (e.g., selection of menu items, gestures, key combinations, and so forth) involving initiation of operations of a computing device with respect to the digital content 112. In an implementation, the usage behavior data 116 describes the number of actions 204 taken over time 206 but does not include personally identifiable information of a user (e.g., user name, demographics) and thus may be employed even in instances in which this information is not available and further protects an identity of a user. Other implementations are also contemplated, however, in which this personally identifiable information may also be leveraged.

A plurality of action distributions is generated based on the usage behavior data 116. The plurality of action distributions 208 describes a change in the number of actions 204 taken by the users (e.g., the user population) with respect to the digital content 112 over time 210 (block 304). A distribution generation module 212, for instance, may be employed by the security breach detection module 114 to describe how a number of actions taken with respect to digital content 112 of the service provider 102 changes over time for the user population. Thus, the action distributions 208 describe, for each action, how these changes are expected to occur for individual user accounts based on the user population and thus may serve as a basis for detection of a likelihood of a security breach as further described below.

A security breach likelihood is detected of a user account of the service provider system 102 by comparing usage behavior data 214 associated with the user account with the generated plurality of action distributions 208 (block 306). A behavior change analysis module 216, for instance, receives usage behavior data 214 of a user account that is under investigation. This usage behavior data 214 is then compared with the action distributions 208 of each of the plurality of actions to determine whether the usage behavior data 214 conforms with the action distributions 208, and thus, changes as expected over time as based on actions 204 taken by the user population.

In one example, the behavior change analysis module 216 computes the likelihood of a security breach as a score. The score is proportional to the likelihood (e.g., probability) that a legitimate user associated with the user account engaged in each action of the plurality of actions as a result of the comparison, e.g., as part of hypothesis testing to reject or accept a null hypothesis as further described below. To do so, the behavior change analysis module 216 computes a probability score that a legitimate user engaged in a respective one of the actions by comparing the user behavior data of the user account with the action distributions. This results in probability score for each of the actions that are multiplied together to achieve the final result 218 (e.g., score) as a probability for the plurality of actions in their entirety.

An alert 218 is then output responsive to a determination that the user account is likely breached based on the detected security breach likelihood (block 308). For example, the result 218 may be output in a user interface 220 for viewing by an engineer at the service provider system 102 for further investigation, such as to determine whether to restrict access based on additional information, such as demographics and so forth. The result 218 may also be passed to a result processing module 222 to perform an operation in response to the result 218 automatically and without user intervention, such as to perform access control 224, control of digital marketing content 226 (e.g., based on changes to segments including the user account to provide targeted advertising), and so forth.

The behavior change analysis module 216 may use a variety of different techniques to detect a likelihood of a security breach. In one example, hypothesis testing is employed, in which a hypothesis is proposed for a statistical relationship and is compared as an alternative to an idealized null hypothesis. In this example, the null hypothesis states that access to a user account is legitimate (e.g., the user accessing the user account is permitted) and a probability is computed of occurrence of a shift in consumer behavior given that the null hypothesis is correct. The behavior charge analysis module 216 is configured to compute this probability to a specified degree of confidence against Type I (i.e., false positive) and Type II (i.e., false negative) errors in order to determine whether to reject the null hypothesis (that access to the user account is legitimate) and from this detect a likelihood of a security breach.

Techniques employed by the behavior change analysis module 216 are based in the following discussion on an assumption that access to a user account involves a choice of any of the possible actions “actionₘ” with a probability “pₘ” The total number of actions 204 “N” is known and fixed. A user associated with a user account “i's” actions 204 performed during in a period of time (e.g., a month) follows a multinomial distribution with probability “Pᵢ” and “N” as the total number of actions. While “N” actually depends on the user associated with the user account, an assumption may be made that how the user actually performs the action can be observed in “Pᵢ.” In the following discussion, the proportion of the actions 204 used is fixed for each user account and thus “N” is not compared.

In this example, instead of taking each of the actions 204 as a whole multinomial distribution, the number of times each of the actions 204 is completed is treated as a binomial distribution, i.e., as an algebraic expression of the sum or the difference of two terms. Although this does not address a correlation between each of the actions, accuracy is not affected significantly while gains are made in computational efficiency.

With a series of binomial distributions for each of the actions 204, if “N” is large, the binomial distributions form a series of normal distributions in accordance with the Central Limit Theorem. In other words, each of the plurality of action distributions 208 follow a normal distribution. For example, suppose that there are two sets of data for the same user account collected over two periods of time, e.g., over two months. If compliance with the central limit theorem is assumed (i.e., the data follows a normal distribution), then the following follows a multivariate normal distribution with a mean of “0” and a variance of “1”:

$${z}_{i} = \frac{{p}_{m 1} - {p}_{m 2} - Δ p}{√ \frac{{P}_{m 1} ( 1 - {p}_{m 1} )}{{N}_{m 1}} + \frac{{P}_{m 2} ( 1 - {P}_{m 2} )}{{N}_{m 2}}}$$

The likelihood of compliance with this distribution (e.g., usage behavior data 214 corresponds to the action distribution 208) is used by the behavior change analysis module 216 to differentiate legitimate access versus security breaches in a manner that addresses changes in user behavior over time. The behavior change analysis module 216 may do so due to a likelihood that large changes in a user behavior are described by resultant statistics since a tail end density of a normal distribution declines exponentially. Therefore, changes that appear as part of a tail of the action distribution 208 as opposed to a central region of the distribution are indicative of a greater likelihood of a breach in security.

In one example, usage behavior data 116 is collected from nine hundred and sixty-five user accounts of a service provider system 102 over a two-month time period. Ninety-six user accounts are first chosen for evaluation while the remaining user accounts are used as the user population. In this instance, there are a multitude of actions 204 that are described in the usage behavior data 116, e.g., 2633 different subcategory of functions from which seventy-one subcategories are selected as commonly used in both months.

In this example, a generative model is employed where a specific individual “i” has conducted “N” actions 204 in relation to the digital content 112. Each of these “N” actions 204 has a probability of “Pₘⁱ” to be part of the subcategories of actions “m.” The probabilities associated with each action for each user account are computed by the behavior change analysis module 216 using Laplace smoothing, i.e., additive smoothing to smooth categorical data. This is to ensure that some of the summary statistics calculated later do not go to infinity since a zero probability in that particular action may result in a zero variance estimate and therefore result in infinite z-values, which refers to values with a supposed normal distribution.

The usage behavior data 116 in this example is portioned into a control group and test group. For the control group, user accounts are compared with each other between different consecutive months, e.g., February and March. As for the test group, each of the user accounts are randomly mixed with another user account to mimic a situation in which a malicious party breaches the user account.

As previously described, the behavior change analysis module 216 is configured to take into account a natural shift in the way users interact with the digital content 112 of the service provider system 102, e.g., from month to month. The change, for instance, may be caused by updates to the digital content 112, changes in season, and so forth.

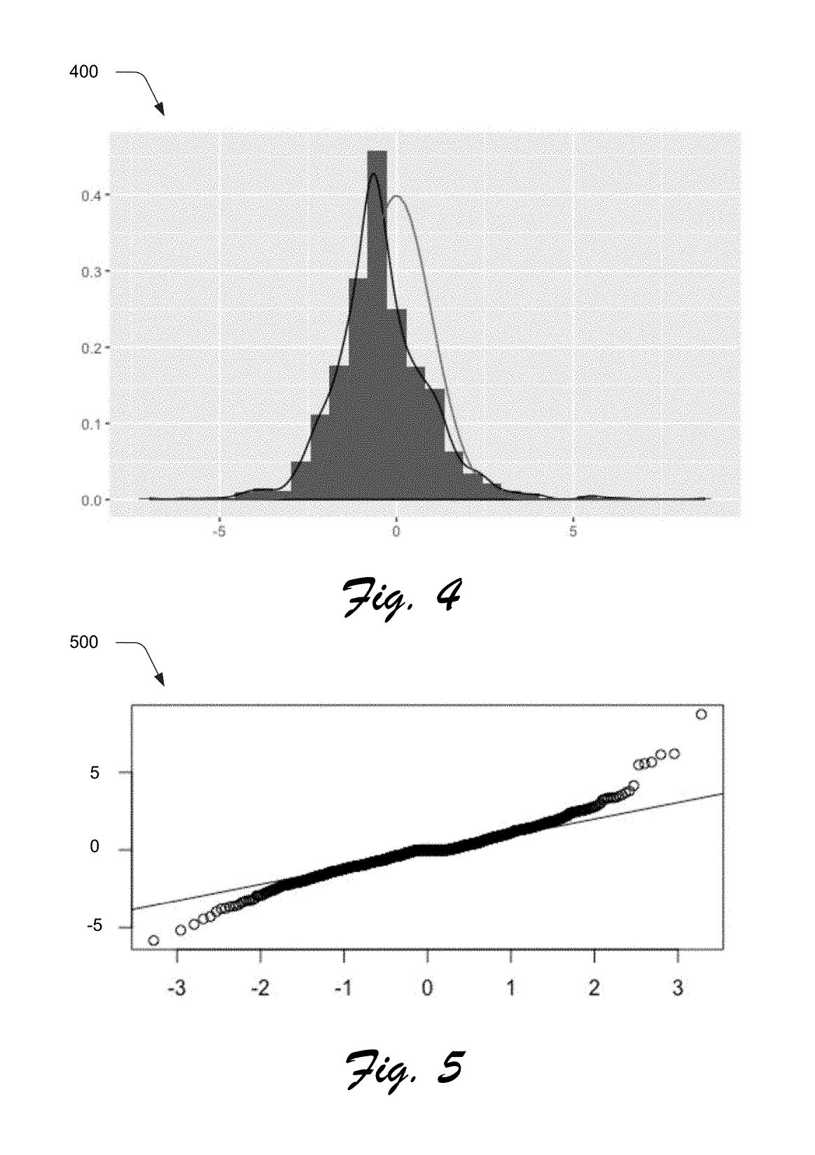

An example of this is exhibited by a distribution 400 of FIG. 4 which depicts a histogram for Z-values tabulated for an action. As observed, the entire distribution 400 is slightly shifted towards the left. The mean in the illustrated distribution 400 is “−0.06356703” rather than actually zero. Other reasons for differences in the null distribution can be attributed to correlation across units, correlation across cases and unobserved covariates. Each of these reasons are sufficient to conclude that the null distribution is not necessarily standard normal, but a standard normal distribution may still be used (e.g., a zero assumption) that assumes that the values around zero are null, which may be expressed as follows:

zᵢ∈[−α,α]⇒zᵢ is Null

This assumption can be seen as an ideal assumption to be made. For example, as shown in a plot 500 of FIG. 5, only extreme values become non-normal while the non-extreme cases fit the normal distribution well. Thus, the standard normal distribution may be employed even though the null distribution does not strictly follow the standard normal distribution.

In this example, the value “α” is set equal to two since ninety-six percent of all the normal distributions is within two standard deviations of the mean. In this sense, extreme cases of user account deviations are captured which have a greater degree of likelihood of exhibiting a security breach. In FIG. 5, these cases are shown to the few values on the rightmost corner of the plot 500 of the histogram. Then, from those values a mean is calculated by the behavior change analysis module 216 to represent the general shift in the users' behavior over the past month. Both the mean and standard error are estimated by the behavior change analysis module 216 using maximum likelihood estimators.

The log-likelihood for each the user is computed by the behavior change analysis module 216 assuming a normal distribution with the computed mean and standard error. An Area Under a receiving characteristic Curve (AUC) is computed by the behavior change analysis module 216 by classifying if there has been security breach in the account using only the log-likelihood statistics of the account. Since the statistics are computed solely based on the individual data, there is no training set and test set in this example. AUC is adopted as a measure in this example because commonly the number user accounts that are compromised is generally small while the weights of having a compromised account might be disproportionally large. Therefore, measuring scales like classification error would result in models which are highly skewed towards making a Type II (false negative) error.

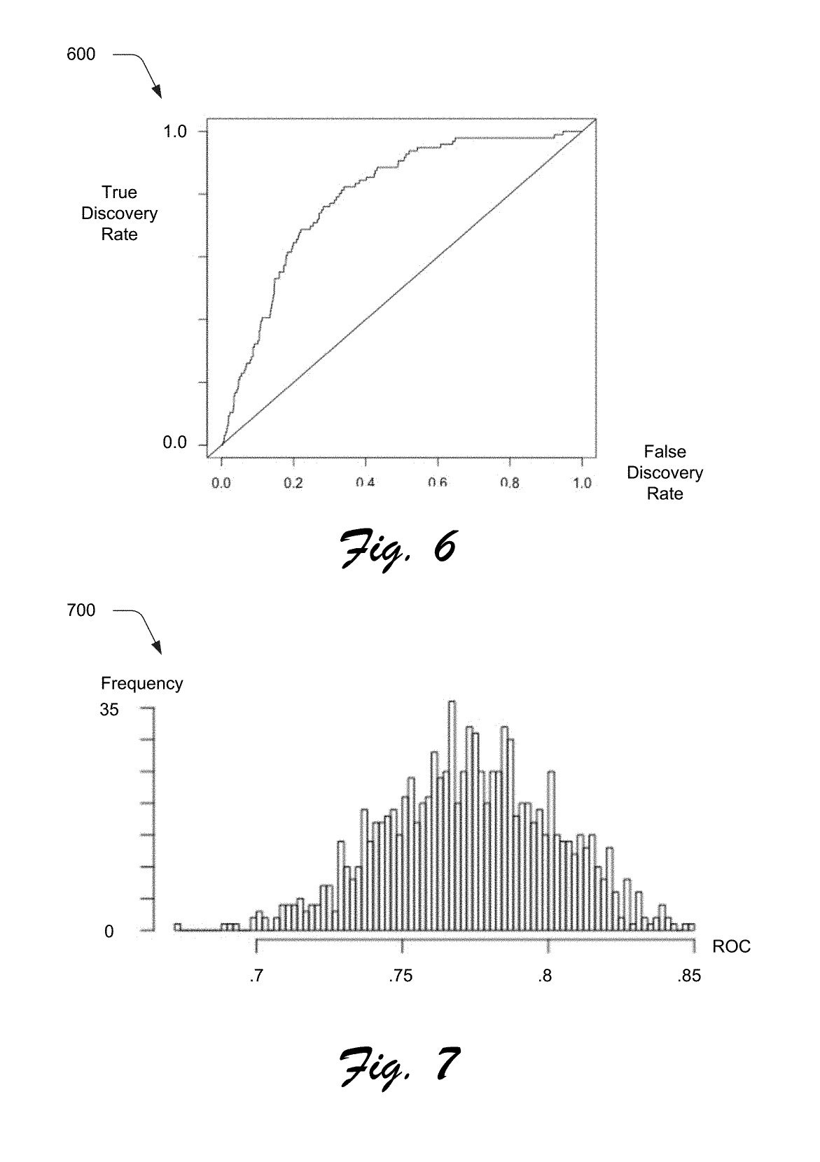

As shown by a receiver operating curve 600 of FIG. 6, a drastic increase in the empirical true discovery rate occurs when the empirical false discovery rate is small. One potential cut-off point is at the point where the empirical false discovery rate (as opposed to a theoretical false discovery rate) is 0.2. This point allows the security breach detection module 114 to detect approximately half of the user account breaches that have occurred while disturbing approximately twenty percent of the user population. In this case, without making a false alarm for the majority of the users, the security breach detection module 114 is able to detect the user accounts that might be compromised. Other examples are also contemplated, such as to adjust a cut-off point to achieve different levels of severity, e.g., in an instance in which the true discovery has increased importance.

FIG. 6 depicts an example of an area under an ROC curve (AUC) 600 as a histogram of an empirical distribution of AUC as shown in FIG. 5. The distribution is concentrated around 0.75 to 0.8 while a standard error is 0.03, which means that it possible to achieve a stable model each time these techniques are applied.

User control may also be supported by the behavior change analysis module 216 to set an amount of sensitivity to be employed with respect to detection of a likelihood of breach of the user accounts. As such, this sensitivity may be used to set a robustness of the behavior change analysis module 216 in detecting false positives.

Additionally, a ROC is plot of the false positive rate against a true positive rate. Thus, the ROC may be used to set the amount of sensitivity to be employed. For example, by examining the ROC graph, the false positive rate is generally relatively low when the true positive rate (which is also called true discovery rate) is high and thus be used as a basis for controlling the amount of sensitivity to achieve a low false positive rate while ensuring a high true positive rate.

Further, these techniques and systems may efficiently address availability of new actions 204 as each of these actions may be addressed independent of each other. This way, a new action score may be added for each new action 204 to update a score used to compute a likelihood of a security breach as described above.

Accordingly, the security breach detection module 114 is configured to detect anomalous behaviors considering the impact and role of time, i.e., that actions 294 taken by a user population changes organically in time (and that is expected) and these kinds of changes does not constitute security breach (or undesirable anomaly). In this way, “expected or organic and natural changes/evolution that take place in time in an individual behavior” is distinguished from “unexpected or non-organic changes or anomalies that constitute security breach”.

A distinguishing characteristic between these two types of anomalies (organic and non-intrusive anomalies versus inorganic security breaches) is that the organic changes in an individual behavior are continuous and smooth (i.e., happen non-abruptly) while the anomalies that constitute security breach are abrupt in the sense that these breaches typically take place in a small span of time. In other words, the security breach detection module 114 is able to adapt to the gradual changes (by learning from the experiences of other user accounts or the user account under investigation itself) in the behavior of a user associated with the user account.

Example Procedure

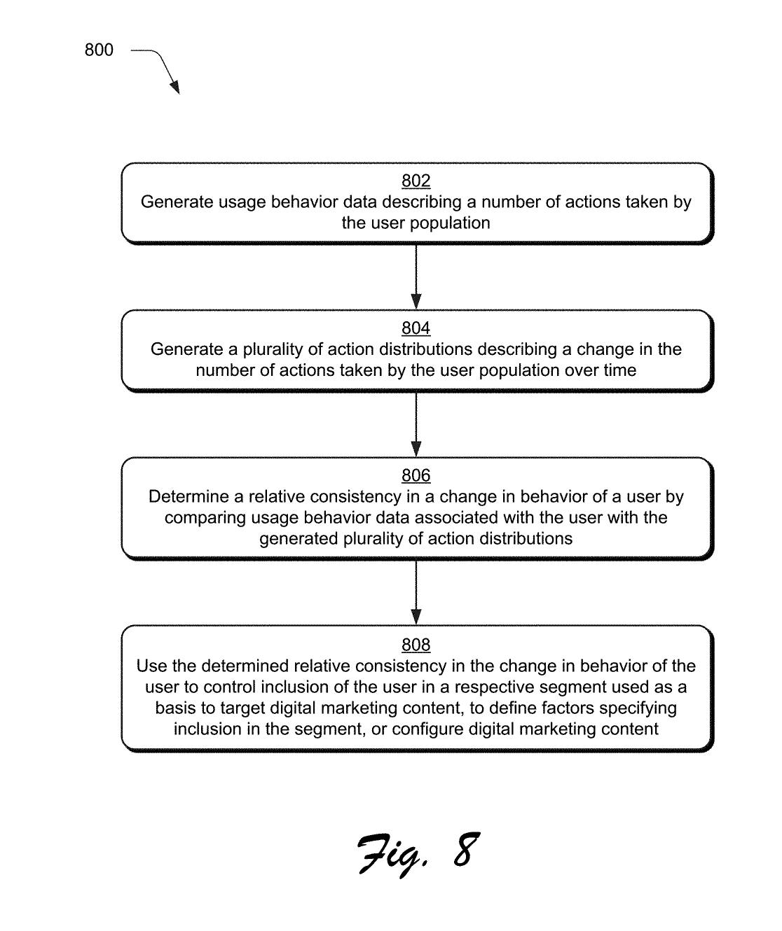

The following discussion describes a technique that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 1-7.

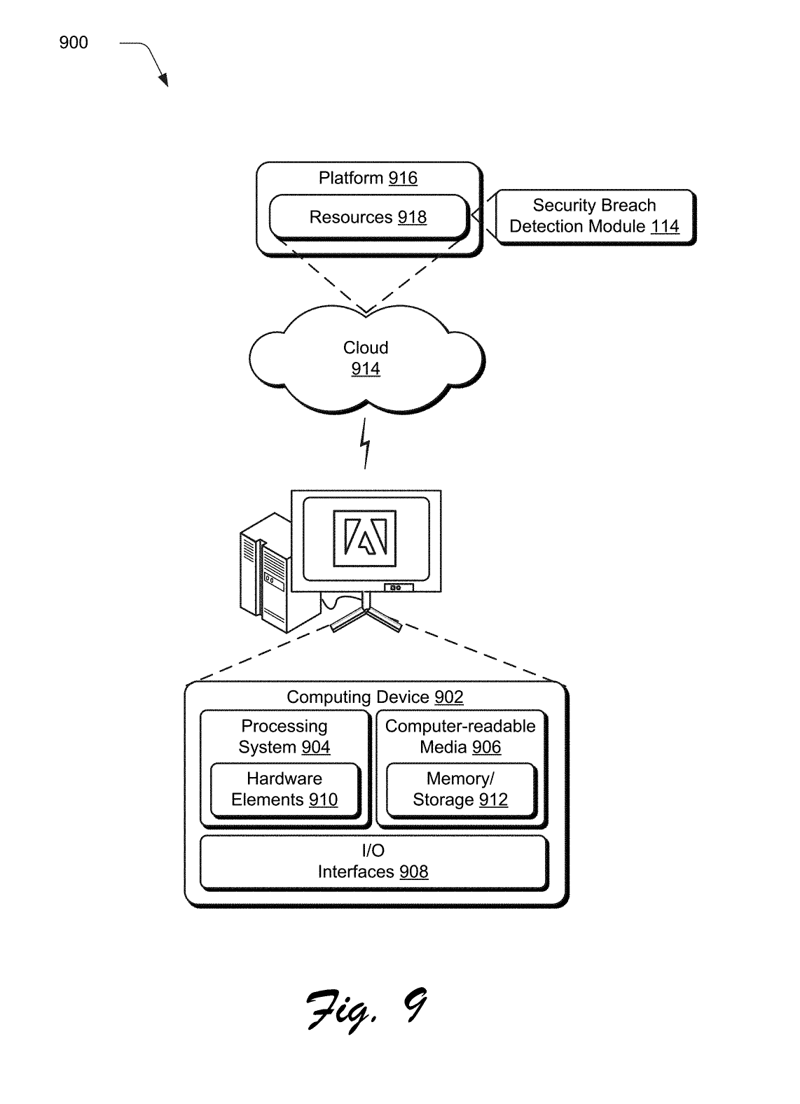

FIG. 8 depicts a procedure 800 in an example implementation in which a determination is made as to a relative consistency in a change in behavior by a user with respect to a user population. In the previous section, detection of a change in behavior is used to detect a likelihood of a security breach of a user account. Detection of this change, through comparison with changes exhibited by a user population, may also be used to support a variety of other functionality. For example, changes in a user behavior may be used to update assignment of a user to a particular segment of a user population that is to serve as a basis to target digital marketing content such as online advertisements, banner ads, notifications, and so forth. In this way, this change may be used to make sure assignment of the user to a particular segment remains accurate. Other examples are also contemplated to address differences in changes of behavior of a user with respect to changes of a user population.

As before, usage behavior data is generated that describes a number of actions taken by the user population (block 802). A plurality of action distributions is generated that describe a change in the number of actions taken by the users over time (block 804). A relative consistency is then determined in a change in behavior of the user by comparing usage behavior data associated with the user with the generated plurality of action distributions (block 806). The determined relative consistency in the change in behavior of the user may then be employed for a variety of purposes, such as to control inclusion of the user in a respective segment used as a basis to target digital marketing content, to define factors specifying inclusion in the segment, or configure digital marketing content (block 808). Thus, functionality represented by the usage behavior monitoring module 202, distribution generation module 212, and behavior change analysis module 216 may be implemented by a variety of other modules and systems independent of security breach detection.

Example System and Device

FIG. 9 illustrates an example system generally at 900 that includes an example computing device 902 that is representative of one or more computing systems and/or devices that may implement the various techniques described herein. This is illustrated through inclusion of the security breach detection module 114. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to detect a security breach, a method implemented by at least one computing device, the method comprising:
receiving, by the at least one computing device, usage behavior data describing a number of actions performed with respect to digital content of a service provider system over time;
generating, by the at least one computing device, a plurality of action distributions based on the usage behavior data, each action distribution of the plurality of action distributions describing a change in the number of times a respective action is performed with respect to the digital content over time;
detecting, by the at least one computing device, a security breach likelihood of a user account of the service provider system by comparing usage behavior data associated with the user account with the generated plurality of action distributions; and
outputting, by the at least one computing device, a security breach likelihood alert responsive to determining that the user account is likely breached based on the detected security breach likelihood.

2. The method as described in claim 1, wherein the digital content is an application or web service made accessible via the user account.

3. The method as described in claim 1, wherein the actions of the usage behavior data involve computer operations initiated by a user population that involve the digital content.

4. The method as described in claim 1, wherein the actions of the usage behavior data also describe characteristics of a user population that initiated the actions.

5. The method as described in claim 1, wherein the detecting includes generating a score based on a likelihood that a legitimate user associated with the user account of the service provider system engaged in each action of the plurality of actions as a result of the comparing.

6. The method as described in claim 5, wherein the generating of the score includes multiplying the likelihood generated for the plurality of actions together.

7. The method as described in claim 1, wherein the detecting includes testing a hypothesis that there is no security breach based on a computed probability of a change in usage behavior regarding the user account by comparing the usage behavior data associated with the user account with the generated plurality of action distributions.

8. The method as described in claim 1, wherein the outputting includes determining that the detected security break likelihood is indicative of a security breach and identifying the user account as potentially having the security breach.

9. The method as described in claim 1, wherein:
the number of actions forms a series of binomial distributions for each action of the plurality of actions; and
the generated plurality of action distributions follows a multivariate normal distribution.

10. In a digital medium environment to determine consistency of a change in behavior of a user with respect to a user population, a system comprising:
a usage behavior monitoring module implemented at least partially in hardware of a computing device to generate usage behavior data describing a number of actions taken by the user population;
a distribution generation module implemented at least partially in hardware of the computing device to generate a plurality of action distributions describing a change in the number of actions taken by the user population over time; and
a behavior change analysis module implemented at least partially in hardware of the computing device to determine a relative consistency in a change in behavior of the user by comparing usage behavior data associated with the user with the generated plurality of action distributions.

11. The system as described in claim 10, wherein the actions are taken with respect to digital content of a service provider system and the determination of the relative consistency in the change in behavior is used to detect a likelihood of a security breach of a user account of the service provider system.

12. The system as described in claim 11, wherein the actions involve computer operations initiated via the service provider system that involve the digital content.

13. The system as described in claim 10, wherein the behavior change analysis module is configured to generate a score based on a likelihood that a user engaged in each action of the plurality of actions as a result of the comparing.

14. The system as described in claim 13, wherein the generation of the score includes multiplying the likelihood generated for the plurality of actions together.

15. The system as described in claim 10, further comprising a result processing module implemented at least partially in hardware of the computing device to use the determined relative consistency in the change in behavior of the user to control inclusion of the user in a respective segment used as a basis to target digital marketing content, to define factors specifying inclusion in the segment, or configure digital marketing content.

16. The system as described in claim 10, wherein:
the number of actions taken by the users forms a series of binomial distributions for each action of the plurality of actions; and
the generated plurality of action distributions follows a multivariate normal distribution.

17. In a digital medium environment to detect a security breach, a system comprising:
means for receiving usage behavior data describing a number of actions taken by users with respect to digital content of a service provider system over time;
means for generating a plurality of action distributions describing a change in the number of actions taken by the users with respect to the digital content over time; and
means for detecting a security breach likelihood of a user account of the service provider system by comparing usage behavior data associated with the user account with the generated plurality of action distributions.

18. The system as described in claim 17, wherein the digital content is an application or web service made accessible via the user account.

19. The system as described in claim 17, wherein the actions involve computer operations initiated by the user that involve the digital content.

20. The system as described in claim 17, wherein:
the number of actions taken by the users forms a series of binomial distributions for each action of the plurality of actions; and
the generated plurality of action distributions follows a multivariate normal distribution.
